(19) United States
(12) Patent Application Publication
(10) Pub. No.: US 2016/0111752 A1
(43) Pub. Date: Apr. 21, 2016

(54) SODIUM MOLTEN-SALT BATTERY AND MOLTEN-SALT ELECTROLYTE OR IONIC LIQUID USED THEREIN

(71) Applicant: SUMITOMO ELECTRIC INDUSTRIES, LTD., Osaka-shi (JP)

(72) Inventors: Atsushi FUKUNAGA, Osaka-shi (JP); Shinji INAZAWA, Osaka-shi (JP); Koji NITTA, Osaka-shi (JP); Shoichiro SAKAI, Osaka-shi (JP); Eiko IMAZAKI, Osaka-shi (JP); Koma NUMATA, Osaka-shi (JP)

(21) Appl. No.: 14/890,122

(22) PCT Filed: Mar. 4, 2014
(86) PCT No.: PCT/JP2014/055397

§ 371 Date: Nov. 9, 2015

(30) Foreign Application Priority Data
May 10, 2013 (JP) 2013-100495

(51) Int. Cl. H01M 10/0566; H01M 10/054

(52) U.S. Cl. CPC H01M 10/0566; H01M 10/054; H01M 2300/0045

(57) ABSTRACT

Provided is a sodium molten-salt battery having good storage characteristics and good charge-discharge cycle characteristics. The sodium molten-salt battery includes a positive electrode that contains a positive electrode active material, a negative electrode that contains a negative electrode active material, and a molten-salt electrolyte that contains a sodium salt and an ionic liquid that dissolves the sodium salt. The ionic liquid contains a salt of an anion and a pyrrolidinium cation having, at the 1-position, a methyl group and an alkyl group having 2 to 5 carbon atoms. A content of 1-methylpyrrolidine in the molten-salt electrolyte is 100 ppm by mass or less.

### TECHNICAL FIELD

The present invention relates to a sodium molten-salt battery that includes a molten-salt electrolyte having sodium ion conductivity. In particular, the present invention relates to an improvement of a molten-salt electrolyte or an ionic liquid contained in a molten-salt electrolyte.

### BACKGROUND ART

In recent years, the demand for non-aqueous electrolyte secondary batteries has been increasing as high-energy density batteries that can store electrical energy. Among non-aqueous electrolyte secondary batteries, molten-salt batteries that use flame-retardant molten-salt electrolytes are advantageous in terms of good thermal stability. In particular, sodium molten-salt batteries that use molten-salt electrolytes having sodium ion conductivity can be produced from inexpensive raw materials and thus are regarded as promising next-generation secondary batteries.

Promising main components of molten-salt electrolytes are ionic liquids which are salts of organic onium cations and anions. For example, PTL 1 proposes ionic liquids that contain various organic onium cations such as a pyrrolidinium cation. However, the history of the development of ionic liquids is short, and ionic liquids containing various minor components as impurities are used at present. Furthermore, there have been few studies on the effects of impurities on molten-salt batteries, and the effects are in an unexplored area.

### CITATION LIST

### Patent Literature

PTL 1: Japanese Unexamined Patent Application Publication No. 2012-134126

### SUMMARY OF INVENTION

### Technical Problem

Among ionic liquids, salts that contain a pyrrolidinium cation having, at the 1-position, a methyl group and an alkyl group having 2 to 5 carbon atoms have high heat resistance and a low viscosity and thus are promising as main components of molten-salt electrolytes. However, in the case of using an ionic liquid that contains a pyrrolidinium cation having, at the 1-position, a methyl group and an alkyl group having 2 to 5 carbon atoms, gas is generated in a sodium molten-salt battery during the storage of the battery and during repeated charge-discharge cycles. As a result, a charge-discharge capacity gradually decreases.

### Solution to Problem

The inventors of the present invention analyzed impurities in various ionic liquids that contained a pyrrolidinium cation having, at the 1-position, a methyl group and an alkyl group having 2 to 5 carbon atoms and evaluated storage characteristics and charge-discharge cycle characteristics of molten-salt batteries including the analyzed ionic liquids. According to the results, it was found that the ionic liquids contained 1-methylpyrrolidine as an impurity. It was also found that the storage characteristics and the charge-discharge cycle characteristics significantly changed with a change in the concentration of 1-methylpyrrolidine.

The present invention has been achieved on the basis of the above findings.

Specifically, an aspect of the present invention relates to a sodium molten-salt battery including a positive electrode that contains a positive electrode active material, a negative electrode that contains a negative electrode active material, and a molten-salt electrolyte that contains a sodium salt and an ionic liquid that dissolves the sodium salt, in which the ionic liquid contains a salt of an anion and a pyrrolidinium cation having, at the 1-position, a methyl group and an alkyl group having 2 to 5 carbon atoms, and a content of 1-methylpyrrolidine in the molten-salt electrolyte is 100 ppm by mass or less.

Another aspect of the present invention relates to a molten-salt electrolyte for a sodium molten-salt battery, the molten-salt electrolyte containing a sodium salt and an ionic liquid that dissolves the sodium salt, in which the ionic liquid contains a salt of an anion and a pyrrolidinium cation having, at the 1-position, a methyl group and an alkyl group having 2 to 5 carbon atoms, and a content of 1-methylpyrrolidine is 100 ppm by mass or less.

Still another aspect of the present invention relates to an ionic liquid for a sodium molten-salt battery, the ionic liquid containing a salt of an anion and a pyrrolidinium cation having, at the 1-position, a methyl group and an alkyl group having 2 to 5 carbon atoms, in which a content of 1-methylpyrrolidine is 100 ppm by mass or less.

### Advantageous Effects of Invention

According to the present invention, storage characteristics and charge-discharge cycle characteristics of a sodium molten-salt battery are improved.

### BRIEF DESCRIPTION OF DRAWINGS

FIG. 1 is a front view of a positive electrode according to an embodiment of the present invention.

FIG. 2 is a cross-sectional view taken along line II-II in FIG. 1.

FIG. 3 is a front view of a negative electrode according to an embodiment of the present invention.

FIG. 4 is a cross-sectional view taken along line IV-IV in FIG. 3.

FIG. 5 is a perspective view of a molten-salt battery according to an embodiment of the present invention, in which a battery case is partially cut out.

FIG. 6 is a schematic longitudinal cross-sectional view taken along line VI-VI in FIG. 5.

### DESCRIPTION OF EMBODIMENTS

### Description of Embodiments of Invention

First, the contents of embodiments of the present invention will be listed and described.

An aspect of the present invention relates to a sodium molten-salt battery including a positive electrode that contains a positive electrode active material, a negative electrode that contains a negative electrode active material, and a molten-salt electrolyte that contains a sodium salt and an ionic liquid that dissolves the sodium salt, in which the ionic liquid contains a salt of an anion and a pyrrolidinium cation having, at the 1-position, a methyl group and an alkyl group having 2 to 5 carbon atoms (hereinafter, may be simply referred to as “pyrrolidinium cation”), and a content of 1-methylpyrrolidine in the molten-salt electrolyte is 100 ppm by mass or less.

By controlling the content of 1-methylpyrrolidine in the molten-salt electrolyte to 100 ppm by mass or less, the generation of gas due to decomposition of the pyrrolidinium cation constituting the ionic liquid is significantly suppressed. Consequently, storage characteristics and charge-discharge cycle characteristics of the sodium molten-salt battery are improved.

Among pyrrolidinium cations, a 1-methyl-1-propylpyrrolidinium cation (MPPY) is particularly preferable. Since MPPY has high heat resistance and forms an ionic liquid having a low viscosity, MPPY is suitable as a main component of the molten-salt electrolyte.

The anion constituting the ionic liquid is preferably a bis(sulfonyl)imide anion. The sodium salt dissolved in the ionic liquid is preferably a salt of a sodium ion and a bis(sulfonyl)imide anion. By using a bis(sulfonyl)imide anion as an anion, a molten-salt electrolyte having high heat resistance and high ion conductivity is easily obtained.

The positive electrode active material is a material that electrochemically intercalates and deintercalates sodium ions. The negative electrode active material may be a material that electrochemically intercalates and deintercalates sodium ions. Alternatively, the negative electrode active material may be metallic sodium, a sodium alloy (such as a Na—Sn alloy), or a metal (such as Sn) that alloys with sodium.

The negative electrode active material contains, for example, non-graphitizable carbon. By using non-graphitizable carbon as the negative electrode active material, the generation of gas due to decomposition of the pyrrolidinium cation is more effectively suppressed.

Next, another aspect of the present invention relates to a molten-salt electrolyte for a sodium molten-salt battery, the molten-salt electrolyte containing a sodium salt and an ionic liquid that dissolves the sodium salt, in which the ionic liquid contains a salt of an anion and a pyrrolidinium cation having, at the 1-position, a methyl group and an alkyl group having 2 to 5 carbon atoms, and a content of 1-methylpyrrolidine is 100 ppm by mass or less. By using the molten-salt electrolyte, a molten-salt battery having good storage characteristics and good charge-discharge cycle characteristics is obtained.

Still another aspect of the present invention relates to an ionic liquid for a sodium molten-salt battery, the ionic liquid containing a salt of an anion and a pyrrolidinium cation having, at the 1-position, a methyl group and an alkyl group having 2 to 5 carbon atoms, in which a content of 1-methylpyrrolidine is 100 ppm by mass or less. By using the ionic liquid, a molten-salt battery having good storage characteristics and good charge-discharge cycle characteristics is obtained.

Note that the ionic liquid is used as a mixture with a sodium salt, and thus the concentration of 1-methylpyrrolidine is diluted. Accordingly, when the content of 1-methylpyrrolidine in the ionic liquid is 100 ppm by mass or less, the content of 1-methylpyrrolidine in the molten-salt electrolyte is also 100 ppm by mass or less.

### Details of Embodiments of Invention

Next, details of embodiments of the present invention will be described.

Components of the sodium molten-salt battery will now be described in detail.

### [Molten-Salt Electrolyte]

The molten-salt electrolyte contains a sodium salt and an ionic liquid that dissolves the sodium salt.

The sodium salt corresponds to a solute of the molten-salt electrolyte. The ionic liquid functions as a solvent that dissolves the sodium salt. The molten-salt electrolyte is a liquid in an operational temperature range of the sodium molten-salt battery.

The molten-salt electrolyte has an advantage in that it has high heat resistance and incombustibility. Accordingly, it is desirable that the molten-salt electrolyte contain as small an amount of a component other than a sodium salt and an ionic liquid as possible. However, various additives may be incorporated in the molten-salt electrolyte in an amount that does not significantly impair heat resistance and incombustibility. So as not to impair heat resistance and incombustibility, the sodium salt and the ionic liquid account for preferably 90% by mass or more, and more preferably 95% by mass or more of the molten-salt electrolyte.

The ionic liquid contains a salt of an anion and a pyrrolidinium cation having, at the 1-position, a methyl group and an alkyl group having 2 to 5 carbon atoms. The pyrrolidinium cation having, at the 1-position, a methyl group and an alkyl group having 2 to 5 carbon atoms is usually produced using 1-methylpyrrolidine as a raw material. For example, a desired pyrrolidinium cation is synthesized by a reaction between 1-methylpyrrolidine and an alkyl halide having an alkyl group having 2 to 5 carbon atoms (for example, propyl bromide or butyl bromide). An example of a reaction formula is as follows. In the formula, PY represents a pyrrolidine ring, X represents a halogen atom, and n=2 to 5.

CH₃—PY+CₙH₂ₙ₊₁—X→X⁻.[CH₃—PY—CₙH₂ₙ₊₁]⁺

The produced pyrrolidinium cation is subjected to, for example, a step of washing with an organic solvent and then purified. However, a significant amount of 1-methylpyrrolidine remains as an impurity in the resulting ionic liquid. Accordingly, the ionic liquid contains 1-methylpyrrolidine as an inevitable impurity in an amount of, for example, about 500 ppm by mass or more.

A molten-salt electrolyte having a 1-methylpyrrolidine content of 100 ppm by mass or less is obtained by more highly purifying an ionic liquid containing 1-methylpyrrolidine synthesized as described above. By using an ionic liquid having a 1-methylpyrrolidine content of 100 ppm by mass or less, the content of 1-methylpyrrolidine in a molten-salt electrolyte which is a mixture of a sodium salt and the ionic liquid also becomes 100 ppm by mass or less.

A method for reducing the concentration of 1-methylpyrrolidine in a synthesized pyrrolidinium cation (for example, a salt of a pyrrolidinium cation and a halide ion), or an ionic liquid or molten-salt electrolyte that contains the pyrrolidinium cation is not particularly limited. Examples of the effective method include a method for purifying any of these liquids with an adsorbent and a method for purifying an ionic liquid by recrystallization.

Examples of the adsorbent include, but are not particularly limited to, activated carbon, activated alumina, zeolite, and molecular sieve.

The above adsorbents usually contain an alkali metal such as potassium or sodium. Accordingly, a pyrrolidinium cation, ionic liquid, or molten-salt electrolyte that has been allowed to pass through an adsorbent cannot be used in lithium molten-salt batteries or lithium ion secondary batteries. This is because charge-discharge characteristics of lithium ion secondary batteries significantly degrade if alkali metal ions such as potassium ions or sodium ions dissolve into the ionic liquid. For example, since the oxidation-reduction potentials of sodium and potassium are higher than that of lithium, a battery reaction of lithium ions is inhibited. In contrast, since sodium molten-salt batteries originally contain sodium ions, charge-discharge characteristics of the sodium molten-salt batteries do not degrade. In addition, the oxidation-reduction potential of sodium is higher than that of potassium, and potassium does not significantly affect charge-discharge characteristics of sodium molten-salt batteries.

The concentration of 1-methylpyrrolidine contained in a molten-salt electrolyte or an ionic liquid can be measured by a method such as gas chromatography.

By reducing the content of 1-methylpyrrolidine in a molten-salt electrolyte, the amount of gas generated in a molten-salt battery is reduced during the storage and charge-discharge cycles. This phenomenon will now be discussed.

In the case where an ionic liquid from which 1-methylpyrrolidine is not sufficiently removed is left to stand at room temperature, a color change due to degradation of a molten-salt electrolyte is observed within a few days. According to an analysis of the degraded molten-salt electrolyte, the molten-salt electrolyte contains a decomposition product of a pyrrolidinium cation. In contrast, in an ionic liquid from which 1-methylpyrrolidine is sufficiently removed, the color change due to degradation of a molten-salt electrolyte is not observed. These results show that 1-methylpyaolidine accelerates a decomposition reaction of a pyrrolidinium cation. When a pyrrolidinium cation is decomposed, gas which is a decomposition product is generated as a result of degradation of a molten-salt electrolyte. In particular, at a high temperature of 90° C. or more, degradation of a molten-salt electrolyte due to the decomposition reaction of a pyrrolidinium cation significantly occurs.

When the content of 1-methylpyrrolidine in a molten-salt electrolyte exceeds a certain amount, the decomposition reaction of a pyrrolidinium cation continuously proceeds regardless of the content, though the details of the decomposition reaction of a pyrrolidinium cation are not known. These results show that 1-methylpyrrolidine acts as a catalyst of the decomposition reaction of a pyrrolidinium cation.

In addition, the generation of gas tends to become significant in the coexistence of metallic sodium. Accordingly, in a molten-salt battery, at least part of the decomposition reaction may proceed as a Hofmann degradation reaction in which metallic sodium participates.

The content of 1-methylpyrrolidine in the molten-salt electrolyte is 100 ppm or less. At a content of about 100 ppm, since the decomposition reaction of a pyrrolidinium cation is significantly suppressed, the generation of gas does not significantly inhibit the performance of a molten-salt battery. However, the content of 1-methylpyaolidine is preferably as low as possible. For example, decomposition of a pyrrolidinium cation is more significantly suppressed by controlling the content of 1-methylpyrrolidine to 100 ppm or less, and furthermore 50 ppm or less.

The anion constituting the ionic liquid may be an anion such as a borate anion, a phosphate anion, or an imide anion. An example of the borate anion is a tetrafluoroborate anion. An example of the phosphate anion is a hexafluorophosphate anion. An example of the imide anion is a bis(sulfonyl)imide anion. However, the anions are not limited thereto. Among these, a bis(sulfonyl)imide anion is preferable. By using a bis(sulfonyl)imide anion, a molten-salt electrolyte having high heat resistance and high ion conductivity is easily obtained.

On the other hand, a bis(sulfonyl)imide anion has a property of increasing activity of a pyrrolidinium cation and accelerating a decomposition reaction thereof. Accordingly, in the case where the ionic liquid is a salt of a pyrrolidinium cation and a bis(sulfonyl)imide anion, it is particularly important to reduce the content of 1-methylpyrrolidine contained in a molten-salt electrolyte in order to reduce the amount of gas generated.

The sodium salt dissolved in the ionic liquid may be a salt of a sodium ion and an anion such as a borate anion, a phosphate anion, or an imide anion. Also in this case, the imide anion is preferably a bis(sulfonyl)imide anion. By using a salt of a sodium ion and a bis(sulfonyl)imide anion, a molten-salt electrolyte having high heat resistance and high ion conductivity is easily obtained.

A sodium ion concentration (which is the same as a concentration of a sodium salt when the sodium salt is a monovalent salt) in the molten-salt electrolyte is preferably 2% by mole or more, more preferably 5% by mole or more, and particularly preferably 8% by mole or more of a cation contained in the molten-salt electrolyte. Such a molten-salt electrolyte has good sodium ion conductivity and easily achieves a high capacity even in the case where charging and discharging are performed with a current at a high rate. The sodium ion concentration is preferably 30% by mole or less, more preferably 20% by mole or less, and particularly preferably 15% by mole or less of the cation contained in the molten-salt electrolyte.

Such a molten-salt electrolyte has a high content of an ionic liquid, has a low viscosity, and easily achieves a high capacity even in the case where charging and discharging are performed with a current at a high rate.

The preferred upper limit and lower limit of the sodium ion concentration may be appropriately combined to determine a preferred range. For example, a preferred range of the sodium ion concentration may be 2% to 20% by mole or 5% to 15% by mole.

Specific examples of the pyrrolidinium cation having, at the 1-position, a methyl group and an alkyl group having 2 to 5 carbon atoms include a 1-methyl-1-ethylpyrrolidinium cation, a 1-methyl-1-propylpyrrolidinium cation (MPPY⁺), a 1-methyl-1-butylpyrrolidinium cation (MBPY⁺), and a 1-methyl-1-pentylpyrrolidinium cation. Among these, MPPY⁺, MBPY⁺, etc. are preferable in view of particularly high electrochemical stability.

The ionic liquid may contain a salt of an anion and an organic onium cation (hereinafter, may be referred to as “second component”) other than the salt of an anion and a pyrrolidinium cation having, at the 1-position, a methyl group and an alkyl group having 2 to 5 carbon atoms. However, the effect of suppressing the generation of gas, the effect being obtained by reducing the content of 1-methylpyrrolidine, becomes significant when the ionic liquid contains the salt of an anion and a pyrrolidinium cation having, at the 1-position, a methyl group and an alkyl group having 2 to 5 carbon atoms in an amount of 30% by mass or more. Accordingly, the present invention is particularly effective when the ionic liquid contains the salt of an anion and a pyrrolidinium cation having, at the 1-position, a methyl group and an alkyl group having 2 to 5 carbon atoms in an amount of 30% by mass or more, and furthermore 50% by mass or more.

Examples of the organic onium cation constituting the second component include nitrogen-containing onium cations other than the above pyrrolidinium cation; sulfur-containing onium cations; and phosphorus-containing onium cations. Among these, nitrogen-containing onium cations are particularly preferable. Besides cations derived from an aliphatic amine, an alicyclic amine, or an aromatic amine (e.g., quaternary ammonium cations), for example, organic onium cations having a nitrogen-containing heterocycle other than the above pyrrolidinium cation (i.e., cations derived from a cyclic amine) are used.

Examples of the quaternary ammonium cation include tetraalkylammonium cations (tetraC₁₋₁₀alkylammonium cations) such as an ethyltrimethylammonium cation, a hexyltrimethylammonium cation, an ethyltrimethylammonium cation (TEA⁺), and a methyltriethylammonium cation (TEMA⁺).

Examples of the sulfur-containing onium cation include tertiary sulfonium cations, such as trialkylsulfonium cations (e.g., triC₁₋₁₀alkylsulfonium cations), namely, a trimethylsulfonium cation, a trihexylsulfonium cation, and a dibutylethylsulfonium cation.

Examples of the phosphorus-containing onium cation include quaternary phosphonium cations such as tetraalkylphosphonium cations (e.g., tetraC₁₋₁₀alkylphosphonium cations), namely, a tetramethylphosphonium cation, a tetraethylphosphonium cation, and a tetraoctylphosphonium cation; and alkyl(alkoxyalkyl)phosphonium cations (e.g., triC₁₋₁₀alkyl(C₁₋₅alkoxyC₁₋₅alkyl)phosphonium cations), namely, a triethyl(methoxymethyl)phosphonium cation, a diethylmethyl(methoxymethyl)phosphonium cation, and a trihexyl(methoxyethyl)phosphonium cation. In the alkyl(alkoxyalkyl)phosphonium cations, the total number of alkyl groups and alkoxyalkyl groups that bond to a phosphorus atom is 4, and the number of alkoxyalkyl groups is preferably 1 or 2.

Examples of the nitrogen-containing heterocycle skeleton include five- to eight-membered heterocycles that have one or two nitrogen atoms as atoms constituting the ring, such as imidazoline, imidazole, pyridine, and piperidine; and five- to eight-membered heterocycles that have one or two nitrogen atoms and other heteroatoms (e.g., oxygen atom and sulfur atom) as atoms constituting the ring, such as morpholine.

The nitrogen atoms which are atoms constituting the ring may have an organic group such as an alkyl group as a substituent. Examples of the alkyl group include alkyl groups having 1 to 10 carbon atoms, such as a methyl group, an ethyl group, a propyl group, and an isopropyl group. The number of carbon atoms of the alkyl group is preferably 1 to 8, more preferably 1 to 4, and particularly preferably 1, 2, or 3.

Specific examples of the organic onium cation having a pyridine skeleton include 1-alkylpyridinium cations such as a 1-methylpyridinium cation, a 1-ethylpyridinium cation, and a 1-propylpyridinium cation. Among these, pyridinium cations having an alkyl group having 1 to 4 carbon atoms are preferable.

Specific examples of the organic onium cation having an imidazoline skeleton include a 1,3-dimethylimidazolium cation, a 1-ethyl-3-methylimidazolium cation (EMI⁺), a 1-methyl-3-propylimidazolium cation, a 1-butyl-3-methylimidazolium cation (BMI⁺), a 1-ethyl-3-propylimidazolium cation, and a 1-butyl-3-ethylimidazolium cation. Among these, imidazolium cations having a methyl group and an alkyl group having 2 to 4 carbon atoms, such as EMI⁺ and BMI⁺, are preferable.

The ionic liquid may contain a salt of a cation of an alkali metal other than sodium and an anion such as a bis(sulfonyl)imide anion. Examples of the cation of such an alkali metal include cations of potassium, lithium, rubidium, and cesium. Among these, potassium is preferable.

Examples of the anion constituting the second component include various anions such as a borate anion, a phosphate anion, and an imide anion. Also in this case, a bis(sulfonyl)imide anion is preferable.

Examples of the bis(sulfonyl)imide anion constituting an anion of the ionic liquid or the sodium salt include a bis(fluorosulfonyl)imide anion [(N(SO₂F)₂⁻], (fluorosulfonyl)(perfluoroalkylsulfonyl)imide anions [such as a (fluorosulfonyl)(trifluoromethylsulfonyl)imide anion ((FSO₂)(CF₃SO₂)N⁻)], and bis(perfluoroalkylsulfonyl)imide anions [such as a bis(trifluoromethylsulfonyl)imide anion (N(SO₂CF₃)₂⁻) and a bis(pentafluoroethylsulfonyl)imide anion (N(SO₂C₂F₅)₂⁻]. The number of carbon atoms of the perfluoroalkyl group is, for example, 1 to 10, preferably 1 to 8, more preferably 1 to 4, and, in particular, 1, 2, or 3. These anions may be used alone or in combination of two or more anions.

Among the bis(sulfonyl)imide anions, a bis(fluorosulfonyl)imide anion (FSI⁻); bis(perfluoroalkylsulfonyl)imide anions such as a bis(trifluoromethylsulfonyl)imide anion (TFSI⁻), a bis(pentafluoroethylsulfonyl)imide anion (PFSI⁻), and a (fluorosulfonyl)(trifluoromethylsulfonyl)imide anion; and the like are particularly preferable.

Specific examples of the molten-salt electrolyte include a molten-salt electrolyte containing a salt of a sodium ion and FSI⁻ (Na.FSI) as a sodium salt and a salt of MPPY⁺ and FSI⁻ (MPPY.FSI) as an ionic liquid, and a molten-salt electrolyte containing a salt of a sodium ion and TFSI⁻ (Na.TFSI) as a sodium salt and a salt of MPPY⁺ and TFSI⁻ (MPPY.TFSI) as an ionic liquid.

In view of the balance of the melting point, viscosity, and ion conductivity of the molten-salt electrolyte, a molar ratio of the sodium salt to the ionic liquid (sodium salt/ionic liquid) is, for example, 2/98 to 20/80, and preferably 5/95 to 15/85.

### [Positive Electrode]

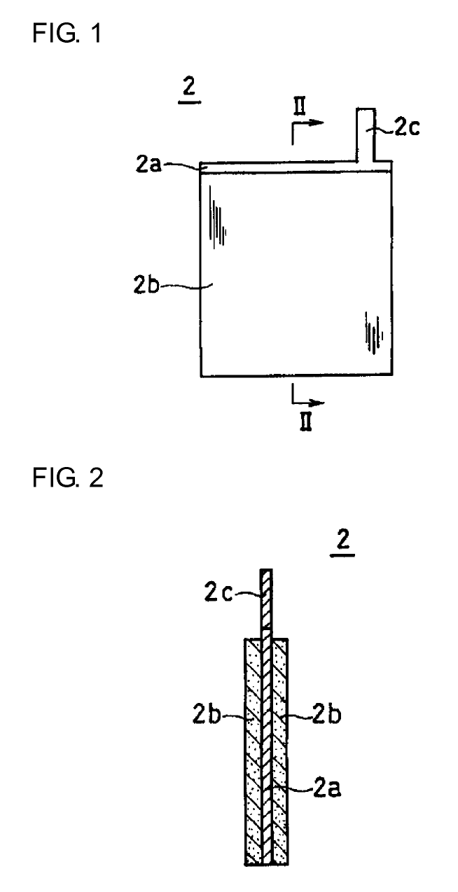

FIG. 1 is a front view of a positive electrode according to an embodiment of the present invention. FIG. 2 is a cross-sectional view taken along line II-II in FIG. 1.

A positive electrode 2 for a sodium molten-salt battery includes a positive electrode current collector 2a and a positive electrode active material layer 2b adhering to the positive electrode current collector 2a. The positive electrode active material layer 2b contains, as an essential component, a positive electrode active material and may contain, as optional components, a conductive carbon material, a binder, etc.

As the positive electrode active material, sodium-containing metal oxides are preferably used. The sodium-containing metal oxides may be used alone or in combination of a plurality of sodium-containing metal oxides. An average particle size (particle size D50 at which the cumulative volume of volume particle size distribution is 50%) of particles of the sodium-containing metal oxide is preferably 2 μm or more and 20 μm or less. The term “average particle size D50” refers to a value measured by a laser diffraction/scattering method using a laser diffraction particle size distribution analyzer, and this also applies hereinafter.

For example, sodium chromite (NaCrO₂) may be used as the sodium-containing metal oxide. Part of Cr or Na of sodium chromite may be replaced with another element. For example, a compound represented by a general formula: Na₁₋ₓM¹ₓCr_{1-y}M²_{y}O₂ (where 0≦x≦⅔, 0≦y≦0.7, and M¹ and M² are each independently a metal element other than Cr and Na) is preferable. In the general formula, x more preferably satisfies 0≦x≦0.5. M¹ and M² are preferably, for example, at least one selected from the group consisting of Ni, Co, Mn, Fe, and Al. Note that M¹ represents an element occupying the Na site, and M² represents an element occupying the Cr site.

Sodium ferromanganate (Na_{2/3}Fe_{1/3}Mn_{2/3}O₂ or the like) may also be used as the sodium-containing metal oxide. Part of Fe, Mn, or Na of sodium ferromanganate may be replaced with another element. For example, a compound represented by a general formula: Na_{2/3-x}M³ₓFe_{1/3-y}Mn_{2/3-z}M⁴_{y+z}O₂ (where 0≦x≦⅔, 0≦y≦⅓, 0≦z≦⅓, and M³ and M⁴ are each independently a metal element other than Fe, Mn, and Na) is preferable. In the general formula, x more preferably satisfies 0≦x≦⅓. M³ and M⁴ are preferably, for example, at least one selected from the group consisting of Ni, Co, and Al. Note that M³ represents an element occupying the Na site, and M⁴ represents an element occupying the Fe or Mn site.

Furthermore, Na₂FePO₄F, NaVPO₄F, NaCoPO₄, NaNiPO₄, NaMnPO₄, NaMn_{1.5}Ni_{0.5}O₄, NaMn_{0.5}Ni_{0.5}O₂, etc. may be used as the sodium-containing metal oxides.

Examples of the conductive carbon material incorporated in the positive electrode include graphite, carbon black, and carbon fibers. The conductive carbon material is used in order to ensure a good conductive path. Among the conductive carbon materials, carbon black is particularly preferable from the viewpoint that a sufficient conductive path can be easily formed by use of a small amount. Examples of carbon black include acetylene black, Ketjenblack, and thermal black.

The amount of conductive carbon material is preferably 2 to 15 parts by mass, and more preferably 3 to 8 parts by mass per 100 parts by mass of the positive electrode active material.

The binder has a function of binding positive electrode active materials to one another and fixing the positive electrode active materials to a positive electrode current collector. Examples of the binder that can be used include fluororesins, polyamides, polyimides, and polyamide-imides. Examples of the fluororesins that can be used include polyvinylidene fluoride (PVDF), polytetrafluoroethylene (PTFE), tetrafluoroethylene-hexafluoropropylene copolymers, and vinylidene fluoride-hexafluoropropylene copolymers. The amount of binder is preferably 1 to 10 parts by mass, and more preferably 3 to 5 parts by mass per 100 parts by mass of the positive electrode active material.

As the positive electrode current collector 2a, a metal foil, a non-woven fabric made of metal fibers, a porous metal sheet, or the like is used. As the metal constituting the positive electrode current collector, aluminum or an aluminum alloy is preferable because it is stable at the positive electrode potential. However, the metal is not particularly limited thereto. In the case where an aluminum alloy is used, the content of a metal component (for example, Fe, Si, Ni, or Mn) other than aluminum is preferably 0.5% by mass or less. The metal foil serving as the positive electrode current collector has a thickness of, for example, 10 to 50 μm. The non-woven fabric made of metal fibers or the porous metal sheet serving as the positive electrode current collector has a thickness of, for example, 100 to 600 μm. A lead piece 2c for current collection may be formed on the positive electrode current collector 2a. The lead piece 2c may be integrally formed with the positive electrode current collector as illustrated in FIG. 1. Alternatively, a lead piece that is separately formed may be joined to the positive electrode current collector by welding or the like.

### [Negative Electrode]

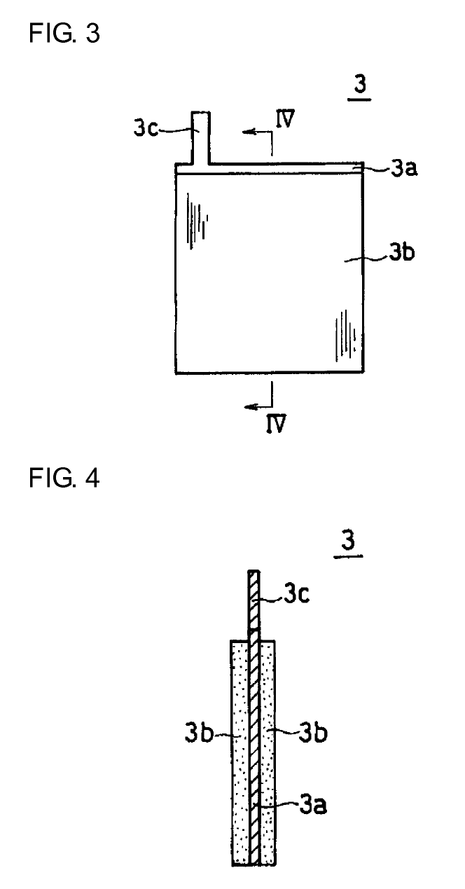

FIG. 3 is a front view of a negative electrode according to an embodiment of the present invention. FIG. 4 is a cross-sectional view taken along line IV-IV in FIG. 3.

A negative electrode 3 includes a negative electrode current collector 3a and a negative electrode active material layer 3b adhering to the negative electrode current collector 3a.

For example, metallic sodium, a sodium alloy, or a metal that alloys with sodium can be used as the negative electrode active material layer 3b. Since the content of 1-methylpyrrolidine contained in the molten-salt electrolyte is 100 ppm or less, the Hofmann degradation of a pyrrolidinium cation is significantly suppressed even in the presence of metallic sodium or the like. The negative electrode includes, for example, a negative electrode current collector composed of a first metal, and a second metal that covers at least a part of a surface of the negative electrode current collector. The first metal is a metal that does not alloy with sodium. The second metal is a metal that alloys with sodium.

As the negative electrode current collector composed of the first metal, a metal foil, a non-woven fabric made of metal fibers, a porous metal sheet, or the like is used. The first metal is preferably, for example, aluminum, an aluminum alloy, copper, a copper alloy, nickel, or a nickel alloy because these metals do not alloy with sodium and are stable at the negative electrode potential. Among these, aluminum or an aluminum alloy is preferable in terms of good lightweight property. For example, aluminum alloys the same as those exemplified for the positive electrode current collector may be used as the aluminum alloy. The metal foil serving as the negative electrode current collector has a thickness of, for example, 10 to 50 μm. The non-woven fabric made of metal fibers or the porous metal sheet serving as the negative electrode current collector has a thickness of, for example, 100 to 600 μm. A lead piece 3c for current collection may be formed on the negative electrode current collector 3a. The lead piece 3c may be integrally formed with the negative electrode current collector as illustrated in FIG. 3. Alternatively, a lead piece that is separately formed may be joined to the negative electrode current collector by welding or the like.

Examples of the second metal include zinc, zinc alloys, tin, tin alloys, silicon, and silicon alloys. Among these, zinc or a zinc alloy is preferable from the viewpoint of good wettability to a molten salt. The negative electrode active material layer formed of the second metal suitably has a thickness of, for example, 0.05 to 1 μm. In a zinc alloy or a tin alloy, the content of a metal component (for example, Fe, Ni, Si, or Mn) other than zinc or tin is preferably 0.5% by mass or less.

An example of a preferred embodiment of the negative electrode includes a negative electrode current collector formed of aluminum or an aluminum alloy (first metal), and zinc, a zinc alloy, tin, or a tin alloy (second metal) that covers at least a part of a surface of the negative electrode current collector. This negative electrode has a high capacity and does not easily degrade for a long period of time.

The negative electrode active material layer formed of the second metal can be obtained by, for example, attaching or compression-bonding a sheet of the second metal to the negative electrode current collector. Alternatively, the second metal may be caused to adhere to the negative electrode current collector by gasifying the second metal by a gas-phase method such as a vacuum deposition method or a sputtering method. Alternatively, fine particles of the second metal may be caused to adhere to the negative electrode current collector by an electrochemical method such as a plating method. A thin, uniform, negative electrode active material layer can be formed by a gas-phase method or a plating method.

The negative electrode active material layer 3b may be a mixture layer containing, as an essential component, a negative electrode active material that electrochemically intercalates and deintercalates sodium ions and, as optional components, a binder, a conductive material, etc. The materials exemplified for components of the positive electrode may be used as the binder and the conductive material used in the negative electrode. The amount of binder is preferably 1 to 10 parts by mass, and more preferably 3 to 5 parts by mass per 100 parts by mass of the negative electrode active material. The amount of conductive material is preferably 5 to 15 parts by mass, and more preferably 5 to 10 parts by mass per 100 parts by mass of the negative electrode active material.

As the negative electrode active material that electrochemically intercalates and deintercalates sodium ions, for example, sodium-containing titanium compounds and non-graphitizable carbon (hard carbon) are preferably used from the viewpoint of thermal stability and electrochemical stability.

The sodium-containing titanium compound is preferably sodium titanate. More specifically, at least one selected from the group consisting of Na₂Ti₃O₇ and Na₄Ti₅O₁₂ is preferably used. Part of Ti or Na of sodium titanate may be replaced with another element. For example, it is possible to use Na₂₋ₓM⁵ₓTi_{3-y}M⁶_{y}O₇ (where 0≦x≦3/2, 0≦y≦8/3, and M⁵ and M⁶ are each independently a metal element other than Ti and Na, and for example, at least one selected from the group consisting of Ni, Co, Mn, Fe, Al, and Cr), Na₄₋ₓM⁷ₓTi_{5-y}M⁸_{y}O₁₂ (where 0≦x≦11/3, 0≦y≦14/3, and M⁷ and M⁸ are each independently a metal element other than Ti and Na, and for example, at least one selected from the group consisting of Ni, Co, Mn, Fe, Al, and Cr), and the like. The sodium-containing titanium compounds may be used alone or in combination of a plurality of compounds. The sodium-containing titanium compound may be used in combination with non-graphitizable carbon. Note that M⁵ and M⁷ each represent an element occupying the Na site, and M⁶ and M⁸ each represent an element occupying the Ti site.

Non-graphitizable carbon is a carbon material in which a graphite structure is not developed even when the material is heated at a high temperature (for example, 3,000° C.) in an inert atmosphere, and in which minute graphite crystals are arranged in random directions, and there are nanometer-order spaces between crystal layers. Since the diameter of an ion of sodium, which is a typical alkali metal, is 0.95 Å, the size of the spaces is preferably sufficiently larger than this value.

The average particle size (particle size D50 at which the cumulative volume of volume particle size distribution is 50%) of non-graphitizable carbon is, for example, 3 to 20 μm, and preferably 5 to 15 μm from the viewpoint of enhancing the filling property of the negative electrode active material in the negative electrode and suppressing side reactions with the electrolyte (molten salt). Furthermore, the specific surface area of non-graphitizable carbon is, for example, 1 to 10 m²/g, and preferably 3 to 8 m²/g from the viewpoint of ensuring the acceptability of sodium ions and suppressing side reactions with the electrolyte. The non-graphitizable carbons may be used alone or in combination of two or more.

An average interlayer distance d₀₀₂ of (002) planes measured by an X-ray diffraction (XRD) spectrum of a carbon material is used as an index of the degree of the development of a graphite-type crystal structure in the carbon material. In general, the average interlayer distance d₀₀₂ of a carbon material classified as graphite is small, namely, less than 0.337 nm. In contrast, the average interlayer distance d₀₀₂ of non-graphitizable carbon having a turbostratic structure is large, for example, 0.37 nm or more. The upper limit of the average interlayer distance d₀₀₂ of non-graphitizable carbon is not particularly limited, but the average interlayer distance d₀₀₂ may be, for example, 0.42 nm or less. The average interlayer distance d₀₀₂ of non-graphitizable carbon is, for example, 0.37 to 0.42 nm, and may be 0.38 to 0.4 nm.

The negative electrode active material preferably contains non-graphitizable carbon and sodium-containing titanium compounds among the above materials. By incorporating non-graphitizable carbon and sodium-containing titanium compounds in the negative electrode active material contained in the mixture layer in an amount of 80% by mass or more, and preferably 100% by mass, the generation of gas due to decomposition of the pyrrolidinium cation is more effectively suppressed. Since non-graphitizable carbon and sodium-containing titanium compounds electrochemically intercalate and deintercalate sodium ions reversibly, deposition of metallic sodium in the negative electrode does not easily occur. Accordingly, it is believed that the progress of a Hofmann degradation reaction of the pyrrolidinium cation is further suppressed.

### [Separator]

A separator may be disposed between the positive electrode and the negative electrode. The material of the separator may be selected in consideration of the operating temperature of the battery. From the viewpoint of suppressing side reactions with molten-salt electrolytes, glass fibers, silica-containing polyolefins, fluororesins, alumina, polyphenylene sulfide (PPS), and the like are preferably used. Among these, a non-woven fabric made of glass fibers is preferable from the viewpoint of a low cost and high heat resistance. Silica-containing polyolefins and alumina are preferable from the viewpoint of good heat resistance. Fluororesins and PPS are preferable from the viewpoint of heat resistance and corrosion resistance. In particular, PPS has good resistance to fluorine contained in molten salts.

The thickness of the separator is preferably 10 to 500 μm, and more preferably 20 to 50 μm. This is because when the thickness is in this range, internal short-circuit can be effectively prevented, and the volume occupancy ratio of the separator to an electrode group can be suppressed to be low and thus a high capacity density can be achieved.

### [Electrode Group]

A sodium molten-salt battery is used in a state in which an electrode group including the positive electrode and the negative electrode, and a molten-salt electrolyte are housed in a battery case. The electrode group is formed by stacking or winding the positive electrode and the negative electrode with a separator interposed therebetween. In this structure, by using a metal battery case and electrically connecting one of the positive electrode and the negative electrode to the battery case, a portion of the battery case can be used as a first external terminal. On the other hand, the other of the positive electrode and the negative electrode is connected, through a lead piece or the like, to a second external terminal which is led to the outside of the battery case in a state of being insulated from the battery case.

Next, a structure of a sodium molten-salt battery according to an embodiment of the present invention will be described. However, it is to be noted that the structure of the sodium molten-salt battery according to the present invention is not limited to the structure described below.

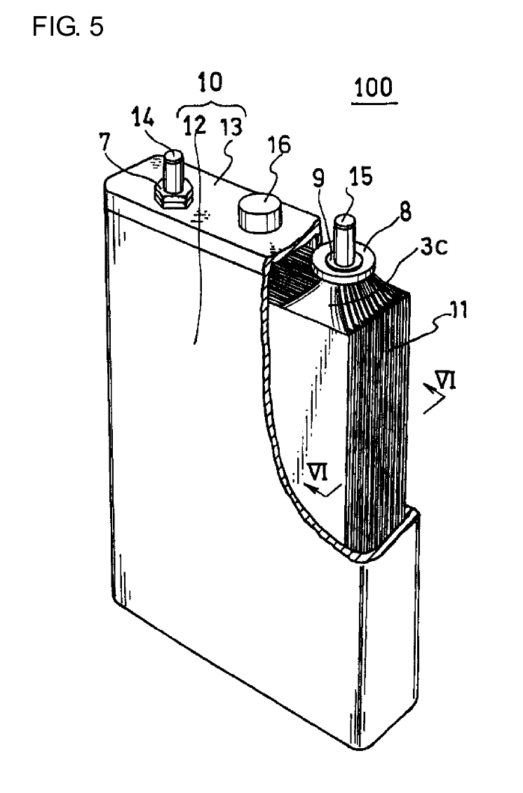

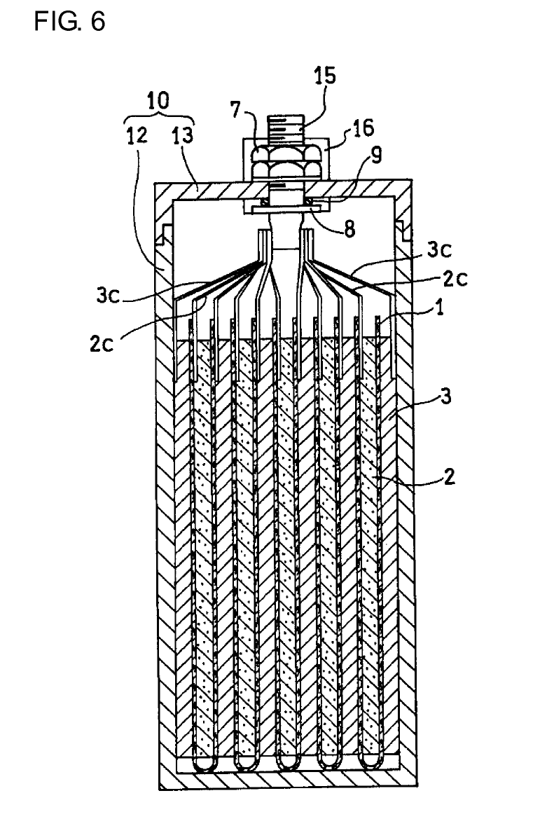

FIG. 5 is a perspective view of a sodium molten-salt battery 100, in which a battery case is partially cut out. FIG. 6 is a schematic longitudinal cross-sectional view taken along the line VI-VI in FIG. 5.

A molten-salt battery 100 includes a stack-type electrode group 11, an electrolyte (not shown), and a rectangular-shaped aluminum battery case 10 which houses these components. The battery case 10 includes a container body 12 having an opening on the top and a closed bottom, and a lid 13 which covers the opening on the top. When the molten-salt battery 100 is assembled, first, the electrode group 11 is formed and inserted into the container body 12 of the battery case 10. Subsequently, a process is performed in which a molten-salt electrolyte is poured into the container body 12, and spaces between a separator 1, a positive electrode 2, and a negative electrode 3 constituting the electrode group 11 are impregnated with the molten-salt electrolyte. Alternatively, after the electrode group is impregnated with the molten-salt electrolyte, the electrode group containing the molten-salt electrolyte may be housed in the container body 12.

An external positive electrode terminal 14 is provided on the lid 13 at a position close to one side, the external positive electrode terminal 14 passing through the lid 13 while being electrically connected to the battery case 10. An external negative electrode terminal 15 is provided on the lid 13 at a position close to the other side, the external negative electrode terminal 15 passing through the lid 13 while being insulated from the battery case 10. A safety valve 16 is provided in the center of the lid 13 for the purpose of releasing gas generated inside when the internal pressure of the battery case 10 increases.

The stack-type electrode group 11 includes a plurality of positive electrodes 2, a plurality of negative electrodes 3, and a plurality of separators 1 interposed therebetween, each having a rectangular sheet shape. In FIG. 6, the separator 1 is formed like a bag so as to enclose the positive electrode 2. However, the form of the separator is not particularly limited. The plurality of positive electrodes 2 and the plurality of negative electrodes 3 are alternately arranged in the stacking direction in the electrode group 11.

A positive electrode lead piece 2c may be formed on one end of each positive electrode 2. By bundling the positive electrode lead pieces 2c of the positive electrodes 2 and connecting the bundle to the external positive electrode terminal 14 provided on the lid 13 of the battery case 10, the positive electrodes 2 are connected in parallel. Similarly, a negative electrode lead piece 3c may be formed on one end of each negative electrode 3. By bundling the negative electrode lead pieces 3c of the negative electrodes 3 and connecting the bundle to the external negative electrode terminal 15 provided on the lid 13 of the battery case 10, the negative electrodes 3 are connected in parallel. The bundle of the positive electrode lead pieces 2c and the bundle of the negative electrode lead pieces 3c are desirably arranged on the right and left sides of one end face of the electrode group 11 with a distance therebetween so as not to be in contact with each other.

Each of the external positive electrode terminal 14 and the external negative electrode terminal 15 is columnar and is provided with a thread groove at least on a portion exposed to the outside. A nut 7 is fit into the thread groove of each terminal. By rotating the nut 7, the nut 7 is fixed to the lid 13. A flange 8 is provided on a portion of each terminal to be housed in the battery case. The flange 8 is fixed to the inner surface of the lid 13 with a washer 9 therebetween by the rotation of the nut 7.

### EXAMPLES

Next, the present invention will be described more specifically on the basis of Examples. However, it is to be understood that the present invention is not limited to the Examples below.

First, the relationship between an ionic liquid and a 1-methylpyrrolidine content was examined.

### Examination of Ionic Liquid

### Comparative Example 1

A commercially available 1-methyl-1-propylpyrrolidinium.bis(fluorosulfonyl)imide (MPPY.FSI: ionic liquid Al) was prepared. The 1-methylpyrrolidine content in the ionic liquid Al was analyzed by gas chromatography. According to the result, the 1-methylpyrrolidine content was 120 ppm.

### Comparative Example 2

A commercially available 1-methyl-1-butylpyrrolidinium.bis(fluorosulfonyl)imide (MBPY.FSI: ionic liquid A2) was prepared. The 1-methylpyrrolidine content in the ionic liquid A2 was analyzed by gas chromatography. According to the result, the 1-methylpyrrolidine content was 190 ppm.

### Examples 1 to 3

The commercially available MPPY.FSI (ionic liquid A1) was sufficiently purified by passing through a column filled with zeolite (HS-320 manufactured by Wako Pure Chemical Industries, Ltd.). However, the concentration of 1-methylpyrrolidine contained in the ionic liquid was changed by adjusting the length of the column. Thereby, an ionic liquid B1 (Example 1) having a 1-methylpyrrolidine content of less than 10 ppm by mass, an ionic liquid B2 (Example 2) having a 1-methylpyrrolidine content of 50 ppm by mass, and an ionic liquid B3 (Example 3) having a 1-methylpyrrolidine content of 98 ppm by mass were prepared.

### Examples 4 to 6

The commercially available MBPY.FSI (ionic liquid A2) was sufficiently purified by passing through a column filled with zeolite (HS-320 manufactured by Wako Pure Chemical Industries, Ltd.). However, the concentration of 1-methylpyrrolidine contained in the ionic liquid was changed by adjusting the length of the column. Thereby, an ionic liquid B4 (Example 4) having a 1-methylpyrrolidine content of less than 10 ppm by mass, an ionic liquid B5 (Example 5) having a 1-methylpyrrolidine content of 50 ppm by mass, and an ionic liquid B6 (Example 6) having a 1-methylpyrrolidine content of 98 ppm by mass were prepared.

### [Evaluation 1]

The ionic liquids of Examples 1 to 6 and Comparative Examples 1 and 2 were stored in a thermostatic chamber at 90° C. for 24 hours. The degree of color change in each of the ionic liquids before and after the storage was examined. Table I shows the results of Examples 1 to 3 and Comparative Example 1. Table II shows the results of Examples 4 to 6 and Comparative Example 2.

TABLE I

| | Comparative | | | |
|---|---|---|---|---|
| | example 1 | Example 1 | Example 2 | Example 3 |
| Ionic liquid | A1 | B1 | B2 | B3 |
| 1-Methylpyrrolidine | 120 ppm | <10 ppm | 50 ppm | 98 ppm |
| content | | | | |
| Degree of color | Significant | No color | No color | No color |
| change | | change | change | change |

TABLE II

| | Comparative | | | |
|---|---|---|---|---|
| | example 2 | Example 4 | Example 5 | Example 6 |
| Ionic liquid | A2 | B4 | B5 | B6 |
| 1-Methylpyrrolidine | 190 ppm | <10 ppm | 50 ppm | 98 ppm |
| content | | | | |
| Degree of color | Significant | No color | No color | No color |
| change | | change | change | change |

Referring to the results shown in Tables I and II, it is understood that, even in the cases where only an ionic liquid is left to stand, decomposition of the pyrrolidinium cation proceeds at a 1-methylpyrrolidine content of more than 100 ppm. It is also understood that, in contrast, decomposition of the pyrrolidinium cation is significantly suppressed by controlling the 1-methylpyrrolidine content to 100 ppm or less.

Next, the relationship between a molten-salt electrolyte and a 1-methylpyrrolidine content was examined.

### Examination of Molten-Salt Electrolyte

### Comparative Example 3

A molten-salt electrolyte A1 composed of a mixture of sodium.bis(fluorosulfonyl)imide (Na.FSI) and MPPY.FSI (ionic liquid A1) that contained 120 ppm by mass of 1-methylpyrrolidine, the Na.FSI and the MPPY.FSI being mixed at a molar ratio of 10:90, was prepared.

### Comparative Example 4

A molten-salt electrolyte A2 composed of a mixture of sodium.bis(fluorosulfonyl)imide (Na.FSI) and MBPY.FSI (ionic liquid A2) that contained 190 ppm by mass of 1-methylpyrrolidine, the Na.FSI and the MBPY.FSI being mixed at a molar ratio of 10:90, was prepared.

### Examples 7 to 9

A molten-salt electrolyte B1 (Example 7) composed of a mixture of sodium.bis(fluorosulfonyl)imide (Na.FSI) and MPPY.FSI (ionic liquid B1) that contained less than 10 ppm by mass of 1-methylpyrrolidine, the Na.FSI and the MPPY.FSI being mixed at a molar ratio of 10:90, was prepared. A molten-salt electrolyte B2 (Example 8) composed of a mixture of Na.FSI and MPPY.FSI (ionic liquid B2) that contained 50 ppm by mass of 1-methylpyrrolidine, the Na.FSI and the MPPY.FSI being mixed at a molar ratio of 10:90, was prepared. A molten-salt electrolyte B3 (Example 9) composed of a mixture of Na.FSI and MPPY.FSI (ionic liquid B3) that contained 98 ppm by mass of 1-methylpyrrolidine, the Na.FSI and the MPPY.FSI being mixed at a molar ratio of 10:90, was prepared.

### Examples 10 to 12

A molten-salt electrolyte B4 (Example 10) composed of a mixture of sodium.bis(fluorosulfonyl)imide (Na.FSI) and MBPY.FSI (ionic liquid B4) that contained less than 10 ppm by mass of 1-methylpyrrolidine, the Na.FSI and the MBPY.FSI being mixed at a molar ratio of 10:90, was prepared. A molten-salt electrolyte B5 (Example 11) composed of a mixture of Na.FSI and MBPY.FSI (ionic liquid B5) that contained 50 ppm by mass of 1-methylpyrrolidine, the Na.FSI and the MBPY.FSI being mixed at a molar ratio of 10:90, was prepared. A molten-salt electrolyte B6 (Example 12) composed of a mixture of Na.FSI and MBPY.FSI (ionic liquid B6) that contained 98 ppm by mass of 1-methylpyrrolidine, the Na.FSI and the MBPY.FSI being mixed at a molar ratio of 10:90, was prepared.

### [Evaluation 2]

The molten-salt electrolytes of Examples 7 to 12 and Comparative Examples 3 and 4 were stored in a thermostatic chamber at 90° C. for 24 hours. The degree of color change in each of the molten-salt electrolytes before and after the storage was examined Table III shows the results of Examples 7 to 9 and Comparative Example 3. Table IV shows the results of Examples 10 to 12 and Comparative Example 4.

TABLE III

| | Comparative | | | |
|---|---|---|---|---|
| | example 3 | Example 7 | Example 8 | Example 9 |
| Molten-salt | A1 | B1 | B2 | B3 |
| electrolyte | | | | |
| 1-Methylpyrrolidine | 120 ppm | <10 ppm | 50 ppm | 98 ppm |
| content | | | | |
| Degree of color | Significant | No color | No color | No color |
| change | | change | change | change |

TABLE IV

| | Comparative | Example | Example | Example |
|---|---|---|---|---|
| | example 4 | 10 | 11 | 12 |
| Molten-salt | A2 | B4 | B5 | B6 |
| electrolyte | | | | |
| 1-Methylpyrrolidine | 190 ppm | <10 ppm | 50 ppm | 98 ppm |
| content | | | | |
| Degree of color | Significant | No color | No color | No color |
| change | | change | change | change |

Referring to the results shown in Tables III and IV, it is understood that, also in the cases where an ionic liquid is mixed with a sodium salt, the same phenomenon as in the cases where only an ionic liquid is left to stand is observed.

### Comparative Example 5

### Fabrication of Positive Electrode

A positive electrode paste was prepared by dispersing 85 parts by mass of NaCrO₂ (positive electrode active material) having an average particle size of 10 μm, 10 parts by mass of acetylene black (conductive carbon material), and 5 parts by mass of polyvinylidene fluoride (binder) in N-methyl-2-pyrrolidone (NMP) serving as a dispersion medium. The resulting positive electrode paste was applied onto one surface of an aluminum foil having a thickness of 20 μm, dried, subjected to rolling, and cut into predetermined dimensions. Thus, a positive electrode including a positive electrode active material layer having a thickness of 80 μm was fabricated. The positive electrode was punched into a coin shape having a diameter of 12 mm or a rectangular shape of 30 mm×60 mm.

### (Fabrication of Negative Electrode)

A negative electrode paste was prepared by dispersing 92 parts by mass of non-graphitizable carbon (negative electrode active material) having an average particle size of 9 μm, a specific surface area of 6 m²/g, and a true density of 1.52 g/cm³ and 8 parts by mass of a polyimide (binder) in NMP. The resulting negative electrode paste was applied onto one surface of a copper foil having a thickness of 18 μm, sufficiently dried, and subjected to rolling. Thus, a negative electrode having a total thickness of 48 μm and including a negative electrode mixture layer with a thickness of 30 μm was fabricated. The negative electrode was punched into a coin shape having a diameter of 14 mm or a rectangular shape of 32 mm×62 mm.

### (Separator)

A polyolefin separator having a thickness of 50 μm and a porosity of 90% was prepared. The separator was also punched into a coin shape having a diameter of 16 mm or a rectangular shape of 34 mm×64 mm.

### (Fabrication of Coin-Type Sodium Molten-Salt Battery)

The coin-shaped positive electrode, negative electrode, and separator were dried sufficiently by heating at 90° C. or higher at a reduced pressure of 0.3 Pa. Subsequently, the coin-shaped positive electrode was placed in a shallow-bottomed, cylindrical container composed of a SUS/Al cladding material. The coin-shaped negative electrode was placed on the positive electrode with the coin-shaped separator therebetween. A predetermined amount of the molten-salt electrolyte Al was poured into the container. The opening of the container was then sealed with a shallow-bottomed, cylindrical sealing plate that was composed of SUS and provided with an insulation gasket on the periphery thereof. In this manner, a pressure was applied to an electrode group including the positive electrode, the separator, and the negative electrode between a bottom surface of the container and the sealing plate, thereby ensuring a contact between the components. Thus, a coin-type sodium molten-salt battery Al having a designed capacity of 1.5 mAh was fabricated.

### (Fabrication of Rectangular Sodium Molten-Salt Battery)

The rectangular positive electrode, negative electrode, and separator were dried sufficiently by heating at 90° C. or higher at a reduced pressure of 0.3 Pa. Subsequently, a lead piece was connected to each of the positive electrode and the negative electrode. The positive electrode and the negative electrode were arranged to face each other with the separator therebetween, thereby forming a flat electrode group. Next, the electrode group was housed in a bag-like container formed of a laminated film that included an aluminum foil as a barrier layer. A predetermined amount of the molten-salt electrolyte Al was poured into the container. An inlet of the bag was then sealed by fusion-bonding in a reduced-pressure atmosphere, but the lead pieces were led from the fusion-bonded portion of the container. Next, the electrode group was pressed in the thickness direction to ensure a contact between the components. Thus, a rectangular sodium molten-salt battery Al having a designed capacity of 24 mAh was fabricated.

### Examples 13 to 15

Coin-type or rectangular sodium molten-salt batteries B1 (Example 13), B2 (Example 14), and B3 (Example 15) were fabricated as in Comparative Example 5 except that the molten-salt electrolytes B1, B2, and B3 were respectively used instead of the molten-salt electrolyte A1.

### Comparative Example 6

A coin-type or rectangular sodium molten-salt battery A2 was fabricated as in Comparative Example 5 except that the molten-salt electrolyte A2 was used instead of the molten-salt electrolyte A1.

### Examples 16 to 18

Coin-type or rectangular sodium molten-salt batteries B4 (Example 16), B5 (Example 17), and B6 (Example 18) were fabricated as in Comparative Example 5 except that the molten-salt electrolytes B4, B5, and B6 were respectively used instead of the molten-salt electrolyte A1.

### [Evaluation 3]

The coin-type sodium molten-salt batteries of Examples 13 to 18 and Comparative Examples 5 and 6 were heated to 90° C. in a thermostatic chamber. In a state in which the temperature was stabilized, charging and discharging were performed for 100 cycles in which the conditions of (1) to (3) below were defined as one cycle. A ratio (capacity retention rate) of the discharge capacity of the 50th cycle or the 100th cycle to the discharge capacity of the first cycle was determined.

(1) Charging at a charging current of 0.2 C up to a charging termination voltage of 3.5 V

(2) Charging at a constant voltage of 3.5 V up to a termination current of 0.01 C

(3) Discharging at a discharging current of 0.2 C down to a discharging termination voltage of 2.5 V

Table V shows the results of the capacity retention rates of Examples 13 to 15 and Comparative Example 5. Table VI shows the results of the capacity retention rates of Examples 16 to 18 and Comparative Example 6.

TABLE V

| | Comparative | Example | Example | Example |
|---|---|---|---|---|
| | example 5 | 13 | 14 | 15 |
| Molten-salt battery | A1 | B1 | B2 | B3 |
| 1-Methylpyrrolidine | 120 ppm | <10 ppm | 50 ppm | 98 ppm |
| content | | | | |
| Capacity retention | 88% | 99% | 97% | 97% |
| rate | | | | |

TABLE VI

| | Comparative | Example | Example | Example |
|---|---|---|---|---|
| | example 6 | 16 | 17 | 18 |
| Molten-salt battery | A2 | B4 | B5 | B6 |
| 1-Methylpyrrolidine | 190 ppm | <10 ppm | 50 ppm | 98 ppm |
| content | | | | |
| Capacity retention | 85% | 99% | 98% | 97% |
| rate | | | | |

Referring to Tables V and VI, it is understood that the capacity retention rate is significantly improved when the content of 1-methylpyrrolidine contained in the molten-salt electrolyte is 100 ppm or less.

### [Evaluation 4]

Charging and discharging of the rectangular sodium molten-salt batteries of Examples 13 to 18 and Comparative Examples 5 and 6 were repeated for 1,000 cycles. An increasing ratio of the battery thickness of the 300th cycle to the battery thickness of the first cycle was determined.

TABLE VII

| | Comparative | Example | Example | Example |
|---|---|---|---|---|
| | example 5 | 13 | 14 | 15 |
| Molten-salt battery | A1 | B1 | B2 | B3 |
| 1-Methylpyrrolidine | 120 ppm | <10 ppm | 50 ppm | 98 ppm |
| content | | | | |
| Thickness increasing | 10% | 2% | 4% | 5% |
| ratio | | | | |

TABLE VIII

| | Comparative | Example | Example | Example |
|---|---|---|---|---|
| | example 6 | 16 | 17 | 18 |
| Molten-salt battery | A2 | B4 | B5 | B6 |
| 1-Methylpyrrolidine | 190 ppm | <10 ppm | 50 ppm | 98 ppm |
| content | | | | |
| Thickness increasing | 13% | 1% | 4% | 5% |
| ratio | | | | |

Referring to Tables VII and VIII, it is understood that a significant effect of suppressing the generation of gas is obtained when the content of 1-methylpyrrolidine contained in the molten-salt electrolyte is 100 ppm or less.

### INDUSTRIAL APPLICABILITY

The sodium molten-salt battery according to the present invention has good storage characteristics and good charge-discharge cycle characteristics. Therefore, the sodium molten-salt battery according to the present invention is useful in applications in which long-term reliability is required, for example, as a large-scale power storage device for household or industrial use and a power source for electric cars, hybrid cars, or the like.

### REFERENCE SIGNS LIST

1: separator, 2: positive electrode, 2a: positive electrode current collector, 2b: positive electrode active material layer, 2c: positive electrode lead piece, 3: negative electrode, 3a: negative electrode current collector, 3b: negative electrode active material layer, 3c: negative electrode lead piece, 7: nut, 8: flange, 9: washer, 10: battery case, 11: electrode group, 12: container body, 13: lid, 14: external positive electrode terminal, 15: external negative electrode terminal, 16: safety valve, 100: molten-salt battery

1. A sodium molten-salt battery comprising:
a positive electrode that contains a positive electrode active material;
a negative electrode that contains a negative electrode active material; and
a molten-salt electrolyte that contains a sodium salt and an ionic liquid that dissolves the sodium salt,
wherein the ionic liquid contains a salt of an anion and a pyrrolidinium cation having, at the 1-position, a methyl group and an alkyl group having 2 to 5 carbon atoms, and
a content of 1-methylpyrrolidine in the molten-salt electrolyte is 100 ppm by mass or less.

2. The sodium molten-salt battery according to claim 1, wherein the pyrrolidinium cation is a 1-methyl-1-propylpyrrolidinium cation.

3. The sodium molten-salt battery according to claim 1, wherein the anion is a bis(sulfonyl)imide anion.

4. The sodium molten-salt battery according to claim 1, wherein the sodium salt is a salt of a sodium ion and a bis(sulfonyl)imide anion.

5. The sodium molten-salt battery according to claim 1, wherein the negative electrode active material contains non-graphitizable carbon.

6. A molten-salt electrolyte for a sodium molten-salt battery, comprising:
a sodium salt; and an ionic liquid that dissolves the sodium salt,
wherein the ionic liquid contains a salt of an anion and a pyrrolidinium cation having, at the 1-position, a methyl group and an alkyl group having 2 to 5 carbon atoms, and
a content of 1-methylpyrrolidine is 100 ppm by mass or less.

7. An ionic liquid for a sodium molten-salt battery, comprising:
a salt of an anion and a pyrrolidinium cation having, at the 1-position, a methyl group and an alkyl group having 2 to 5 carbon atoms,
wherein a content of 1-methylpyrrolidine is 100 ppm by mass or less.
